(19) United States
(12) Patent Application Publication
(10) Pub. No.: US 2011/0284114 A1
(43) Pub. Date: Nov. 24, 2011

(54) Methods for Repairing a Defective Pipeline

(75) Inventors: Nicholas John Venero, Clinton, NY (US); Raymond Nicholas Burke, Cypress, TX (US); Timothy James Morten Bond, Cypress, TX (US)

(73) Assignee: PIPESTREAM B.V., Houston, TX (US)

(21) Appl. No.: 12/784,617

(22) Filed: May 21, 2010

(51) Int. Cl. F16L 55/16

(52) U.S. Cl. 138/99

(57) ABSTRACT

Methods for repairing a defect in a pipeline. In some embodiments, the method includes filling the defect with a paste such that an outer surface of the defect is substantially flush with an adjacent outer surface of the pipeline, curing the paste, manually wrapping a reinforcing material around the pipeline over the defect region for a plurality of turns, coupling the reinforcing material to the pipeline, wherein a pressure load applied to an inner surface of the pipeline is transferred through the pipeline and the paste to the reinforcing material so as to increase a safe operating pressure of the pipeline, and electrically coupling the reinforcing material and the pipeline, whereby an electrical potential in the pipeline is transmitted to the reinforcing material.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The disclosure relates to repair of tubulars subjected to internal pressure, including pipelines that convey fluid under pressure. More particularly, the disclosure relates to methods for repairing a defect in an exterior surface of a pipeline while the pipeline continues to transport fluid under pressure.

Pipelines may be constructed from a variety of different materials. Within the energy industry, homogeneous steel pipelines are most commonly used to transport fluids under pressure. To transport a fluid through a pipeline, an internal pressure differential is created in the fluid by pumping stations or a reservoir pressure. In response to the internal pressure differential in the fluid, stresses are created through the wall of the pipeline. For this reason, design, manufacture, and installation techniques are carefully applied to ensure that the pipeline can withstand the required fluid pressure. Even so, situations may arise through the life of the pipeline that create defects in the pipe, compromising the integrity of the pipeline.

Types of pipeline defects and their causes are varied. Some defects include dents, gouges, dents with gouges, and external corrosion leading to wall loss in the form of pits and crevices in the pipe wall. The two main causes of these types of defects are external interference, such as impacts to the pipeline with an excavator, or external corrosion created by a reaction between the pipeline steel and the surrounding environment. The presence of defects can lead to a local reduction in the strength of the pipeline, which, in turn, reduces the safe working pressure of the pipeline. Also, the fatigue life of the pipeline may be significantly reduced, particularly in the presence of dents or dents with gouges.

Pipeline defects are commonly detected by the use of “smart pigs,” which are devices that travel through the pipeline with the flow of the fluid and use a variety of techniques to measure and record the presence of dents or reductions in the wall thickness of the pipeline. Upon detection of a defect, assessment methods are then employed to determine the severity of the defect. If the defect is determined to be severe, the pipeline operator may be required to reduce the operating pressure of fluid in the pipeline to remain within safe working limits of the defective pipeline. In such circumstances, repair techniques are also often employed to allow operators to safely reinstate the original working pressure without compromising the integrity of the pipeline.

Prior to the repair process, the defect region of the pipeline is typically prepared. For a buried pipeline, preparation of the defect region may include locating the defect, excavating to expose the defect, inspecting the defect, and removing the coating and sand blasting the pipeline in the defect region. At this point, the pipeline is ready to be repaired.

A number of different techniques and structures can be employed to reinforce the defect region of the pipeline. One widely used repair method involves positioning of two split sleeves about the pipeline over the defect region. The split sleeves are then coupled together, such as by bolting or welding. Also, the split sleeves may be welded to the pipeline. Due to their weight, a crane is required to lift and position the split sleeves about the pipeline. Consequently, the use of split sleeves is limited to sites where a crane is both available and capable of being located proximate the defect region of the pipeline. Moreover, achieving the required fit of the sleeve about the pipeline can be difficult, requiring highly skilled welders and specialized welding equipment. The pipeline operator, however, may not permit welding to a live pipeline due to safety concerns. As such, it may be necessary to interrupt flow through the pipeline to allow for proper fitting and installation of the sleeve.

Another widely used repair method involves the application of composite materials around the pipeline over the defect region. Composite materials are susceptible to creep, have significantly reduced structural properties at elevated temperatures, may degrade over time due to moisture absorption, and can be adversely affected by soil stresses. For these reasons, many pipeline operators do not believe that composite materials provide a permanent repair.

### SUMMARY OF THE DISCLOSURE

Methods for repairing a defect in a tubular or pipeline are disclosed. In some embodiments, the method includes filling the defect with a paste such that an outer surface of the defect is substantially flush with an adjacent outer surface of the pipeline; curing the paste; manually wrapping a reinforcing material around the pipeline over the defect for a plurality of turns; and coupling the reinforcing material to the pipeline, wherein a pressure load applied to an inner surface of the pipeline is transferred through the pipeline and the paste to the reinforcing material so as to increase a safe operating pressure of the pipeline. The method further includes electrically coupling the reinforcing material and the pipeline, whereby an electrical potential in the pipeline is transmitted to the reinforcing material.

In some embodiments, the method includes filling the defect with a paste such that an outer surface of the defect is substantially flush with an adjacent outer surface of the pipeline; applying an adhesive over a portion the pipeline including the defect; manually wrapping a reinforcing material around the pipeline over the defect; applying the adhesive between adjacent turns of the reinforcing material; and curing the paste and the adhesive, whereby a pressure load applied to an inner surface of the pipeline is transferred through the pipeline and the paste in the defect to the reinforcing material so as to increase the safe operating pressure of the pipeline.

In some embodiments, the method includes attaching a hose clamp comprising a worm gear housing and a band extending therefrom to one end of a reinforcing material having two ends; electrically coupling the other end of the reinforcing material to an installed pipeline proximate the defect; filling the defect with a paste such that an outer surface of the defect is substantially flush with an adjacent outer surface of the pipeline; manually wrapping the reinforcing material around the pipeline over the defect for one or more turns; coupling the hose clamp around the wrapped reinforcing material; and tensioning the hose clamp, such that a pressure load applied to an inner surface of the pipeline is transferred through the pipeline and the paste to the reinforcing material so as to increase the safe operating pressure of the pipeline.

In some embodiments, a kit of parts forming a pipeline repair system for application to a pipeline having a defect includes a paste adapted for application to the pipeline, whereby the defect is filled with the paste, and a coil of reinforcing material adapted for wrapping around the pipeline over the defect. The paste is adapted to cure after application to the pipeline, whereby a pressure load applied to an inner surface of the pipeline is transferred through the pipeline and the paste in the defect to the reinforcing material so as to increase the safe operating pressure of the pipeline.

Thus, the embodiments described herein comprise a combination of features and characteristics intended to address various shortcomings associated with conventional pipeline repair methods. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the disclosed embodiments, reference will now be made to the accompanying drawings in which:

FIG. 1 is schematic representation a pipeline repair system in accordance with the principles disclosed herein installed on a pipeline;

FIGS. 2A and 2B are axial and radial cross-sectional views, respectively, of the pipeline repair system of FIG. 1;

FIG. 3A is a cross-sectional view of the reinforcing material of FIGS. 2A and 2B, illustrating its metal strip and external coating.

FIG. 4 is perspective view of an another embodiment of a pipeline repair system in accordance with the principles disclosed herein;

FIG. 5 is an enlarged view of an end of the reinforcing material of FIG. 4 pin brazed to a pipeline having a defect; and

FIG. 6 is a perspective side view of the repair system of FIG. 4, installed about the pipeline over the defect region.

### DETAILED DESCRIPTION OF THE DISCLOSED EMBODIMENTS

The following description is directed to exemplary embodiments of methods for repairing a defective pipeline. The embodiments disclosed should not be interpreted, or otherwise used, as limiting the scope of the disclosure, including the claims. One skilled in the art will understand that the following description has broad application, and that the discussion is meant only to be exemplary of the described embodiment, and not intended to suggest that the scope of the disclosure, including the claims, is limited to that embodiment.

Certain terms are used throughout the following description and the claims to refer to particular features or components. As one skilled in the art will appreciate, different persons may refer to the same feature or component by different names. This document does not intend to distinguish between components or features that differ in name but not function. Moreover, the drawing figures are not necessarily to scale. Certain features and components described herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections. Further, the terms “axial” and “axially” generally mean along or parallel to a central or longitudinal axis, while the terms “radial” and “radially” generally mean perpendicular to the central or longitudinal axis.

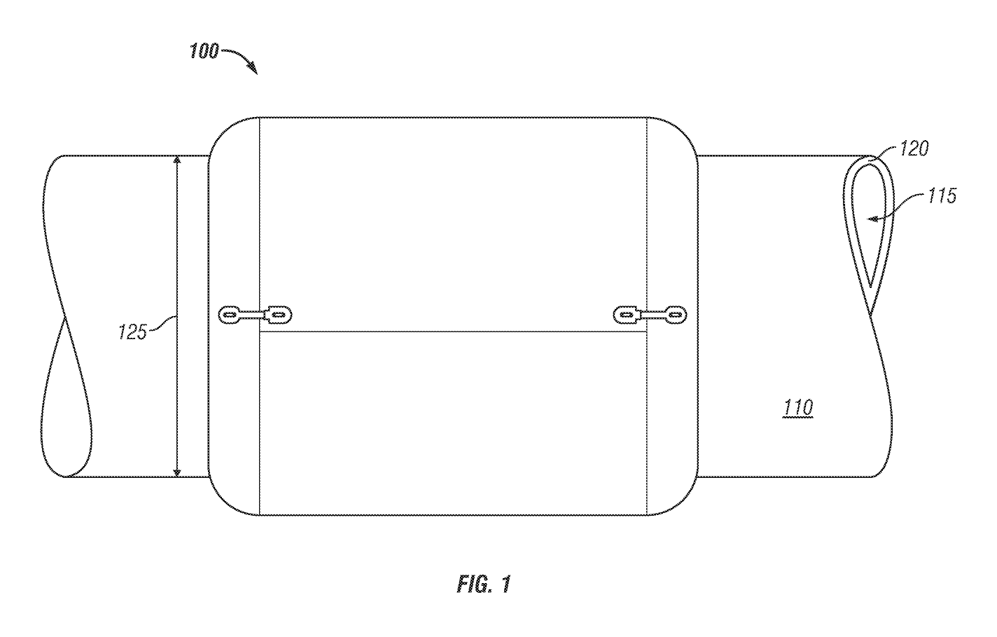

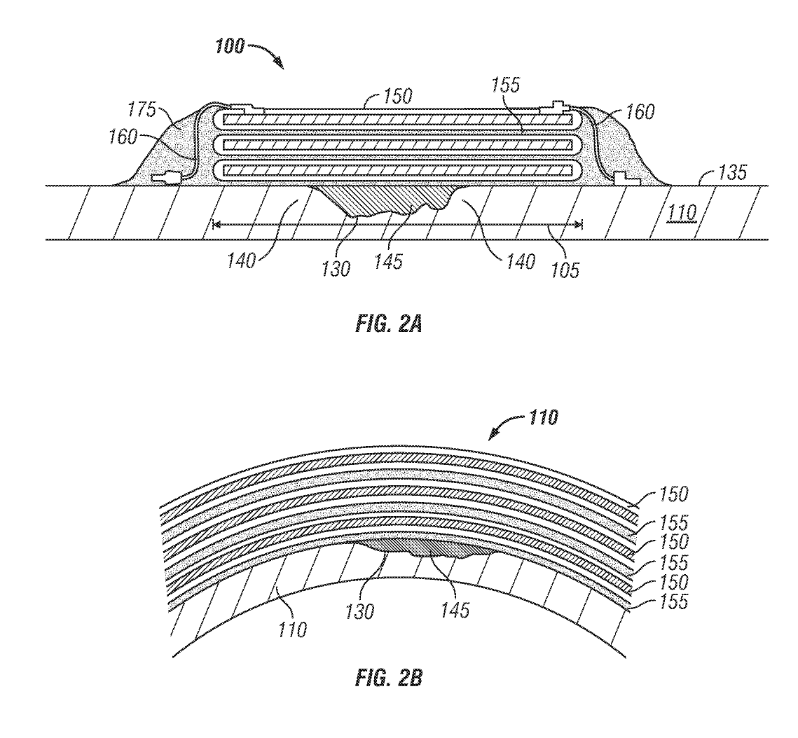

Referring now to FIG. 1, a schematic representation of a pipeline repair system 100 in accordance with the principles disclosed herein. Pipeline repair system 100 is coupled about a defect region 105 (FIG. 2A) of an installed pipeline 110 to repair pipeline 110. As used herein, the expression “to repair” means to reinforce pipeline 110, whereby the safe operating pressure of pipeline 110 is increased. In at least some embodiments, repair of pipeline 110 enables an increase in the safe operating pressure of pipeline 110 such that the safe operating pressure of pipeline 110 returns to substantially its value in the absence of pipeline defects.

Pipeline 110 is a tubular having an internal flowbore 115, a surrounding wall 120, and outer diameter 125, the latter as-designed and installed. During operation, pipeline 110 conveys a pressurized fluid through flowbore 115. Consequently, the fluid exerts a pressure over the inner surface of wall 120, inducing stresses across wall 120. Pipeline 110 may be buried. In such cases, excavation is required to expose defect region 105 prior to its repair. Also, pipeline 110 may be metallic, for example, a steel pipeline, or nonmetallic, such as a tubular formed of a composite material(s).

Turning to FIGS. 2A and 2B, defect region 105 of pipeline 110 includes a defect 130 formed in an outer surface 135 of pipeline 110 and a portion 140 of pipeline 110 surrounding defect 130. Defect 130 may be a dent, a gouge, a dent with a gouge, external corrosion causing material loss in the form of pits and crevices in pipeline 110, and/or a combination thereof. Surrounding portion 140 includes an inner portion, wherein the local strength of pipeline 110 is reduced by the presence of defect 130, and an outer region, wherein the local strength of pipeline 110 is unaffected by defect 130. The remainder of pipeline 110 outside of defect region 105 is unaffected by the presence of defect 130 and thus has a strength substantially as designed, assuming no other defects exist in pipeline 110.

Repair system 100 includes a layer of a paste 145, reinforcing material 150, adhesive 155 applied to pipeline 110 over defect region 105 between adjacent layers of reinforcing material 150, and optional bonding cables 160 coupled therebetween. Prior to the application of repair system 100, pipeline 110 is preferably prepared. In some embodiments, preparation of pipeline 110 includes locating defect region 105 of pipeline 110, excavating pipeline 110, if buried, to expose defect region 105, removing any outer coating applied to defect region 105, such as a coating applied for corrosion protection, and sand blasting of defect region 105. In some embodiments, a bell hole excavation is performed to expose defect region 105. Sand blasting is performed to ensure defect region 105 of pipeline 110 is free of contaminants to promote bonding of repair system 100 to defect region 105.

The innermost layer of repair system 100 is paste 145. Paste 145 is applied to defect region 105 for at least two purposes. First, paste 145 is applied so as to fill in defect 130 and return the outer surface of defect region 105 to a smooth, rounded surface consistent with the remainder of outer surface 135 of pipeline 110. This enables bonding of reinforcing material 150 over defect region 105 via adhesive 155, as will be described. Second, once applied and cured, if necessary, paste 145 transfers load or stress from defective region 105 of pipeline 110 to reinforcing material 150, enabling minimal strain to defect region 105 when pipeline 110 is operational, and thus under pressure from fluid passing therethrough.

Given its function, paste 145 preferably includes a material(s) having high compressive stiffness and strength. To facilitate application of paste 145 to defect region 105 of pipeline 110, the material(s) of paste 145 also preferably has a high viscosity, high sag resistance, high compressive strength at an elevated temperature, and a relatively short setting or curing time, for example, 30 minutes. These properties enable application of paste 145 about the circumference of pipeline 110 with minimal, or no, dripping. In some embodiments, paste 145 is a thermosetting resin comprising a two-part epoxy, such as RenPaste® 157 manufactured by Huntsman Advanced Materials Co. Ltd., headquartered at Office Tower, Langham Place, 8 Argyle Street in Hong Kong.

After paste 145 is applied to defect region 105 and sufficient time has been allotted for curing, if needed, reinforcing material 150 is then wrapped around and coupled to pipeline 110 over defect region 105. Reinforcing material 150 comprises a steel strip having a thickness, width, and length. The thickness is selected for ease of handling, while the width may be dependent upon the width of defect region 105. The length is selected as a function of diameter 125 of pipeline 110 and the number of turns, or times, reinforcing material 150 is to be wrapped around pipeline 110. In some embodiments, the number of turns may be selected, even optimized, dependent upon the diameter and thickness of pipeline 110, the properties of pipeline 110, such as but not limited to its tensile strength and/or yield strength, and the size of defect 130, including its width, defined in the axial direction, and depth, if such information can be determined with sufficient accuracy. In the absence of accurate information, worst case estimates of these parameters may be assumed and the number of turns determined.

The steel strip is preformed in a spiral coil having a weight enabling it to be carried to an installation site by no more than two technicians. This requirement eliminates the need for a lifting crane, or other lifting device, to transport reinforcing material 150 to the installation site and position it about defect region 105 of pipeline for subsequent coupling thereto. In some embodiments, each coil of reinforcing material 150 weighs no more than 40 lbs. Moreover, the coil is formed using a slip roll such that it has a diameter slightly less than diameter 125 of pipeline 110. This allows the coil to naturally hold to pipeline 110 without assistance and thus eases installation of reinforcing material 150. In circumstances where there is limited clearance around at least a portion of defect region 105, the coil diameter may be reduced to ease installation of it.

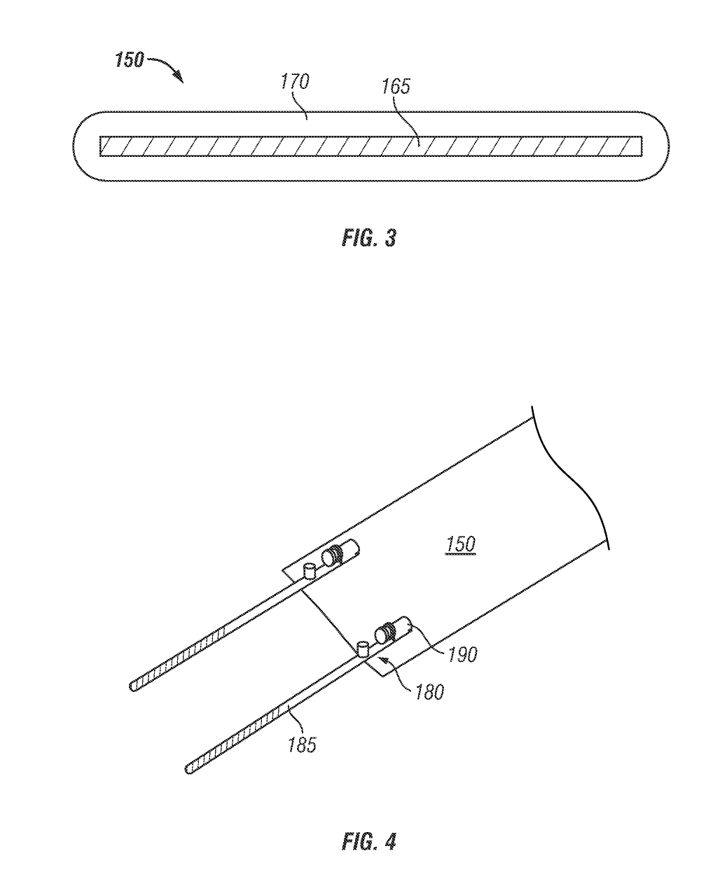

In preferred embodiments, illustrated by FIG. 3, reinforcing material 150 comprises a low-carbon steel strip 165 with a martensitic structure and a high tensile strength created by annealing, quenching, and tempering cold rolled sheet steel. Steel strip 165 is coated with an external coating 170 to protect strip 165 from corrosion. External coating 170 must be compatible with adhesive 155 and with cathodic protection of pipeline 110, if present. Also, external coating 170 must protect steel strip 165 from corrosion for the remainder of the life of pipeline 110.

Referring again to FIGS. 2A and 2B, a layer of adhesive 155 is applied over defect region 105 prior to applying the first turn of reinforcing material 150. Adhesive 155 must be compatible with paste 145 so that the curing and function of each are not adversely affected by the other. Like paste 145, adhesive 155 may be a two-part epoxy. In some embodiments, adhesive 155 is Araldite® 8579, also manufactured by Huntsman Advance Materials. After application of adhesive 155 to defect region 105, reinforcing material 150 is then wrapped around defect region 105. After the first turn of reinforcing material 150 is completed, a second layer of adhesive 155 is applied to the exterior of the first turn. A second turn of reinforcing material 150 is then wrapped around defect region 105, and so on. Reinforcing material 150 and adhesive 155 are applied in an alternating fashion until the required number of turns has been applied to defect region 105.

After the last turn is applied, a pair of strap wrenches is used to tighten reinforcing material 150 about defect region 105 and one or more hose clamps are coupled about reinforcing material 150 to secure it in position for sufficient time to allow adhesive 155 to cure. After adhesive 155 has cured, repair of defect region 105 is complete, and the hose clamps are removed from pipeline 110. Once secured to pipeline 110 over defect region 105 in this manner, reinforcing material 150 is load bearing, increasing the local strength of pipeline 110 in defect region 105 and thus the structural capacity of pipeline 110.

In some embodiments, repair system 100 harnesses a cathodic protection potential applied to pipeline 110 to provide further corrosion protection to reinforcing material 150 in the event that external coating 170 becomes damaged, exposing steel strip 165 to the surrounding environment. In such embodiments, one or more bonding cables 160, preferably comprising copper, are coupled to reinforcing material 150 prior to transporting reinforcing material 150 to the installation site. Specifically, an end of each bonding cable 160 is pin brazed to steel strip 165 of reinforcing material 150 proximate the end of reinforcing material 150 that, when applied to defect region 105 of pipeline 110, will be disposed at the exterior of repair system 100, rather than adjacent the innermost layer of adhesive 155. After reinforcing material 150 is applied to defect region 105 at the installation site, the other end of each bonding cable 160 is pin brazed to outer surface 135 of pipeline 110 adjacent but outside of defect region 105 and away from any applied paste 145, as best viewed in FIG. 2A. The ends of repair system 100 are then capped with a filler material 175 to prevent ingress of moisture and allowed to cure prior to removal of the hose clamps, as previously described. In some embodiments, filler material 175 comprises RenPaste® 157.

In the previously described embodiment, reinforcing material 150 is secured to defect region 105 by adhesive 155. In other embodiments, reinforcing material 150 may be secured to defect region 105 by other means. FIGS. 4 through 7 illustrate one such embodiment wherein reinforcing material 150 is secured to pipeline 110 over defect region 105 by a worm gear hose clamp 180 that replaces adhesive 155.

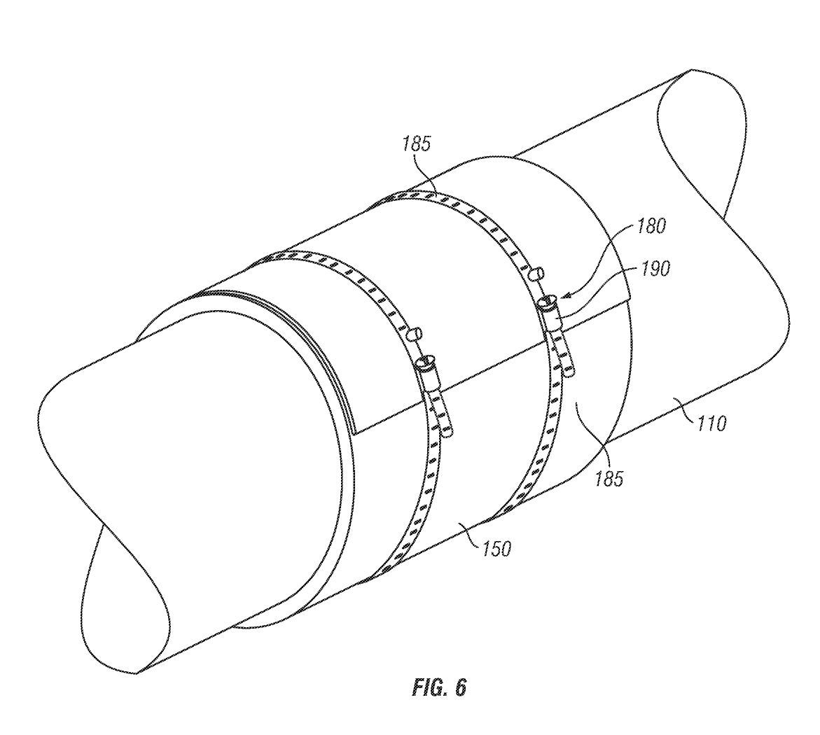

After forming a coil of reinforcing material 150, as previously described, worm gear hose clamp 180 is coupled to an end of reinforming material 150, as illustrated by FIG. 4. In the illustrated embodiment, hose clamp 180 is riveted to reinforcing material 150. Worm gear hose clamp 180 includes a band 185 and a worm gear housing 190. Band 185 has a first end coupled to a worm gear housing 190 and a second end (FIG. 6) that is insertable into housing 190 and locked thereto such that band 185 may not disengage housing 190. After coupling of worm gear hose clamp 180 thereto, reinforcing material 150 is then unrolled and recoiled so that the worm gear hose clamp 180 is at the interior of the coil of reinforcing material. Thus, after the full length of the coil is wrapped around pipeline 110 during installation, hose clamp 180 will be positioned at the exterior of reinforcing material 150, rather than between defect region 105 and reinforcing material 150.

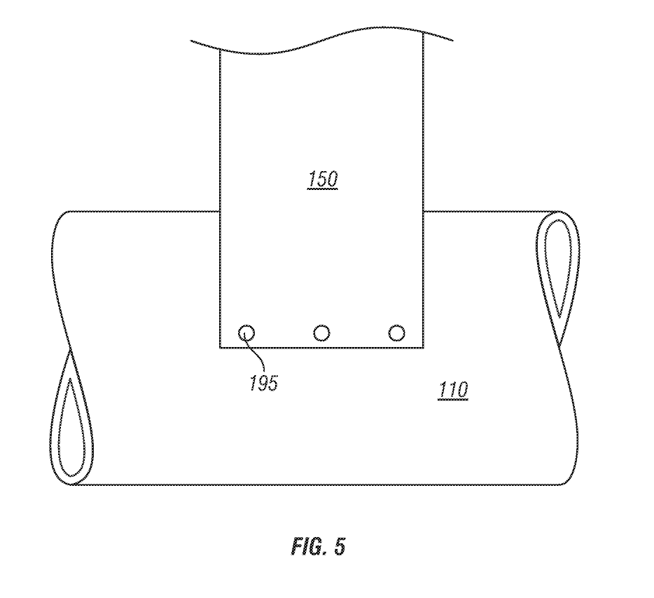

After arriving at the installation site and preferably prior to application of paste 145 to defect region 105, metal strip 165 proximate an end of reinforcing material 150 is pin brazed at one or more locations to pipeline 110, as illustrated by FIG. 5. The end of reinforcing material 150 which does not have hose clamp 180 coupled thereto is the end of reinforcing material 150 pin brazed to pipeline 110. The points of attachment, with respect to pipeline 110, are outside of defect region 105 yet proximate defect region 105 so that when reinforcing material 150 is wrapped around pipeline 110, reinforcing material 150 covers defect region 105. Pin brazing reinforcing material 150 to pipeline 110 in this manner enables a tension load to be applied to reinforcing material 150 during and subsequent to wrapping, as will be discussed, and provides an electrical coupling between pipeline 110 and metal strip 165 of reinforcing material 150. Thus, a cathodic protection current passing through pipeline 110 may be harnessed to further protect reinforcing material 150 from corrosion without the need for bonding cables 160 previously described. Excess brazing material 195 in then removed such that the exterior surface of reinforcing material 150 at the brazing locations is substantially flush with the remaining portions of the exterior surface, as shown.

After reinforcing material 150 is pin brazed to pipeline 110, paste 145 is applied to the full circumference of pipeline 110, including defect region 105. Paste 145 fills in defect 130 and returns the outer surface of defect region 105 to a smooth, rounded surface consistent with the remainder of outer surface 135 of pipeline 110 and after curing, transfers load or stress from defective region 105 of pipeline 110 to reinforcing material 150. In this embodiment, paste 145 also enables bonding of reinforcing material 150 to pipeline 110.

Reinforcing material 150 is then manually wrapped around defect region 105. At the same time, a tension load is manually applied to reinforcing material 150 to minimize any slack in the concentric layers. Once the full length of reinforcing material 150 has been wrapped around pipeline 110, the free end of band 185 of hose clamp 180 is then wrapped around installed reinforcing material 150 and inserted through worm gear housing 190, as illustrated by FIG. 6. To complete installation of repair system 100 about defect region 105, a tension load is applied to band 185 via worm gear housing 190 to remove any slack in band 185 and to secure band 185 about reinforcing material 150 and pipeline 110 disposed therein.

In the exemplary embodiment, repair system 100 includes worm gear hose clamp 180. One having ordinary skill in the art will readily appreciate that another type of coupling device may be used in place of hose clamp 180. For example, hose clamp 180 may be replaced with a nonmetallic buckle and band coupled thereto, such as a Smart Band® manufactured by HCL Fasteners, Inc. located at 3130 Rogerdale Road in Houston, Tex. 77042. Alternatively, hose clamp 180 may be replaced with a plastic hose clamp, such as a Herbie Clip® or Ezyclik™, also manufactured by HCL Fasteners, Inc.

While various embodiments have been shown and described, modifications thereof can be made by one skilled in the art without departing from the spirit and teachings herein. The embodiments herein are exemplary only, and are not limiting. Many variations and modifications of the systems and methods disclosed herein are possible and within the scope of the invention. Accordingly, the scope of protection is not limited by the description set out above, but is only limited by the claims which follow, that scope including all equivalents of the subject matter of the claims.

1. A method of repairing a defect in a pipeline with an inner surface, an outer surface, and a safe operating pressure, the method comprising:
filling the defect with a paste such that an outer surface of the defect is substantially flush with the adjacent outer surface of the pipeline;
curing the paste;
manually wrapping a reinforcing material around the pipeline over the defect region for a plurality of turns;
coupling the reinforcing material to the pipeline;
electrically coupling the reinforcing material and the pipeline, whereby an electrical potential in the pipeline is transmitted to the reinforcing material; and
wherein a pressure load applied to the inner surface of the pipeline is transferred through the pipeline and the paste to the reinforcing material so as to increase the safe operating pressure of the pipeline.

2. The method of repairing a defect in a pipeline of claim 1, wherein the paste comprises a two-part epoxy.

3. The method of repairing a defect in a pipeline of claim 1, further comprising preforming the reinforcing material into a coil.

4. The method of repairing a defect in a pipeline of claim 1, wherein the reinforcing material comprises a metal strip and an external coating applied thereto.

5. The method of repairing a defect in a pipeline of claim 1, wherein electrically coupling comprises brazing an end of a bonding cable to the pipeline and the other end of the bonding cable to the reinforcing material.

6. The method of repairing a defect in a pipeline of claim 1, wherein coupling the reinforcing material comprises:
applying an adhesive between the pipeline and the reinforcing material and between adjacent turns of the reinforcing material; and
curing the adhesive.

7. The method of repairing a defect in a pipeline of claim 6, wherein the adhesive comprises a two-part epoxy.

8. The method of repairing a defect in a pipeline of claim 1, wherein electrically coupling comprises brazing an end of the reinforcing material to the pipeline.

9. The method of repairing a defect in a pipeline of claim 8, wherein coupling the reinforcing material comprises:
attaching a hose clamp to another end of the reinforcing material, the hose clamp comprising a worm gear housing and a band extending therefrom;
wrapping the band around the reinforcing material;
locking the band to the worm gear housing; and
tensioning the band.

10. A method of repairing a defect in a pipeline with an inner, an outer surface, and a safe operating pressure, the method comprising:
filling the defect with a paste such that an outer surface of the defect is substantially flush with the adjacent outer surface of the pipeline;
applying an adhesive over a portion the pipeline including the defect;
manually wrapping a reinforcing material around the pipeline over the defect;
applying the adhesive between adjacent turns of the reinforcing material; and
curing the paste and the adhesive, whereby a pressure load applied to an inner surface of the pipeline is transferred through the pipeline and the paste in the defect to the reinforcing material so as to increase the safe operating pressure of the pipeline.

11. The method of repairing a defect in a pipeline of claim 10, wherein the reinforcing material comprises a metal strip and an external coating applied thereto.

12. The method of repairing a defect in a pipeline of claim 10, further comprising electrically coupling the reinforcing material and the pipeline, whereby an electrical potential in the pipeline is transmitted to the reinforcing material.

13. The method of repairing a defect in a pipeline of claim 12, wherein said electrically coupling comprises brazing an end of a bonding cable to the pipeline and the other end of the bonding cable to the reinforcing material.

14. The method of repairing a defect in a pipeline of claim 10, wherein one of the adhesive and the paste comprises a two-part epoxy.

15. The method of repairing a defect in a pipeline of claim 10, wherein the pipeline is nonmetallic.

16. A method of repairing a defect in a pipeline with an inner and outer surface and
a safe operating pressure, the pipeline repair method comprising:
attaching a hose clamp comprising a worm gear housing and a band extending therefrom to one end of a reinforcing material having two ends;
electrically coupling the other end of the reinforcing material to an installed pipeline proximate the defect;
filling the defect with a paste such that an outer surface of the defect is substantially flush with the adjacent outer surface of the pipeline;
manually wrapping the reinforcing material around the pipeline over the defect for one or more turns;
coupling the hose clamp around the wrapped reinforcing material; and
tensioning the hose clamp, such that a pressure load applied to an inner surface of the pipeline is transferred through the pipeline and the paste to the reinforcing material so as to increase the safe operating pressure of the pipeline.

17. The pipeline repair method of claim 16, wherein further comprising curing the paste.

18. The pipeline repair method of claim 16, wherein the reinforcing material comprises a metal strip and an external coating applied thereto.

19. The pipeline repair method of claim 18, wherein electrically coupling comprises brazing an end of the reinforcing material to the pipeline.

20. The pipeline repair method of claim 16, wherein coupling the reinforcing material comprises:
wrapping the band around the reinforcing material;
locking the band to the worm gear housing; and
tensioning the band.

21. A kit of parts forming a pipeline repair system for application to a pipeline having a defect, the kit of parts comprising:
a paste adapted for application to the pipeline, whereby the defect is filled with the paste;
a coil of reinforcing material adapted for wrapping around the pipeline over the defect; and
wherein the paste is adapted to cure after application to the pipeline, whereby a pressure load applied to an inner surface of the pipeline is transferred through the pipeline and the paste in the defect to the reinforcing material so as to increase the safe operating pressure of the pipeline.

22. The kit of parts of claim 21, further comprising an adhesive for application between adjacent layers of the reinforcing material.

23. The kit of parts of claim 22, wherein the paste and the adhesive are adapted to cure after application to the pipeline, whereby the pressure load applied to the inner surface of the pipeline is transferred through the pipeline and the paste in the defect to the reinforcing material so as to increase the safe operating pressure of the pipeline.

23. The kit of parts of claim 21, further comprising one or more bonding cables for coupling between the reinforcing material and the pipeline, whereby an electric potential in the pipeline is transmitted to the reinforcing material.

24. The kit of parts of claim 21, further comprising a coupling device adapted to couple about the reinforcing material after the reinforcing material is applied to the pipeline, whereby a pressure load applied to an inner surface of the pipeline is transferred through the pipeline and the paste to the reinforcing material so as to increase the safe operating pressure of the pipeline.

25. The kit of parts of claim 24, wherein the coupling device comprises a hose clamp having a worm gear housing and a band coupled thereto.

26. The kit of parts of claim 21, wherein the reinforcing material comprises a metal strip and an external coating applied thereto.
